(19) United States
(12) Patent Application Publication
(10) Pub. No.: US 2005/0000541 A1
(43) Pub. Date: Jan. 6, 2005

(54) Method of cleaning screen printing frames

(76) Inventors: Peter Goth Engel, Rungsted Kyst (DK); Claus Hjorth Madsen, Vedbaek (DK)

Correspondence Address: Finnegan, Henderson, Farabow,;Garrett & Dunner, L.L.P., 1300 I Street, N.W., Washington, DC, 20005-3315, US

(21) Appl. No.: 10/843,684

(22) Filed: May 12, 2004

Related U.S. Application Data
(63) Continuation of application No. 10/032,573, filed on Jan. 2, 2002, now abandoned.
Application No. 10/032,573 is a continuation of application No. 08/849,175, filed on Jul. 18, 1997, now abandoned.

(30) Foreign Application Priority Data
Nov. 30, 1994 (DK) 1366/94

(51) Int. Cl. B08B 3/00; B08B 7/04; B08B 7/00

(52) U.S. Cl. 134/10; 134/38; 134/30; 134/21

(57) ABSTRACT

In a method of cleaning screen printing frames, wherein the frame is contacted with a cleaning liquid which is capable of dissolving or washing out ink residues present in and/or on the screen fabric, and wherein cleaning liquid present in the screen fabric after dissolution of the ink residues is removed, environmental problems are avoided in that the removal of the cleaning liquid takes place by entraining it in a gas flow, and then the entrained liquid is preferably separated from the gas flow.

The present invention concerns a method of cleaning screen printing frames, whereby the frame is contacted with a cleaning liquid which is capable of dissolving or washing out ink residues present in and/or on the screen fabric, and wherein cleaning liquid present in the screen fabric after dissolution or washing of the ink residues is removed.

It has long been known to clean screen printing frames of ink residues by washing with special cleaning liquids, which generally contain heavy organic compounds and optionally an emulsifier.

Washing of screen printing frames may be performed e.g. by means of the system developed by the applicant and described in WO patent specification No. 92/05961. In systems of this type, the screen printing frame is contacted with cleaning liquid by manually moving a flushing hose with a brush mounted thereon across the screen fabric.

This provides effective washing out of ink residues. However, the method is vitiated by the drawback that a relatively large amount of cleaning liquid remains in and/or on the screen fabric. For the screen printing frame to be used for printing again, it is thus necessary to clean the screen fabric of cleaning liquid. When working with a cleaning liquid without emulsifier, this may be done by allowing the screen printing frame to stand in a strongly ventilated room, so that the cleaning liquid evaporates from the screen fabric and is discharged through a ventilation shaft. When working with a cleaning liquid with emulsifier, this may be done by re-flushing the screen printing frame with associated screen fabric with water, which is subsequently discharged.

However, both of the above-mentioned methods for removing cleaning liquid from screen fabrics are vitiated by the drawback that they are relatively time-consuming and impose a pollution load on the environment, as discharge of cleaning liquid vapours through ventilation shafts gives rise to pollution of the atmosphere, and re-flushing with water gives rise to a waste water problem.

As is known, enterprises are to meet ever stricter environmental requirements, in particular as regards discharge of gases and liquids containing organic solvents.

Accordingly, an object of the invention is to provide a simple and quick method of cleaning screen printing frames, whereby discharge of cleaning liquid to the surroundings is essentially avoided.

This is achieved by the method of the invention which is characterized in that removal of the cleaning liquid takes place by entraining it in a gas flow, and then the entrained liquid is preferably separated from the gas flow.

When working with a cleaning liquid without emulsifier, said liquid is removed to such a degree that the screen printing frame can immediately be used for printing again.

When working with an emulsifier-containing cleaning liquid, said liquid is removed to such a degree that the screen fabric has a thin liquid film residue thereon, which may then be removed together with the last ink residues by flushing with water, without the discharged waste water giving rise to an unacceptable pollution load of the environment.

In a preferred embodiment, the maximum rate of the gas flow is in the range 5-60 m/s, preferably 10-45 m/s, in particular 15-30 m/s.

In a particularly preferred embodiment, removal of the cleaning liquid is performed by suction under vacuum by means of a suction nozzle which is moved across the screen fabric.

Having been sucked off from the screen fabric, the cleaning liquid is preferably passed to a separation zone where the cleaning liquid is separated and collected. The collected cleaning liquid may be re-used for washing screen printing frames.

For reasons of health and safety at work, the discharge gas is passed from the separation zone preferably to a ventilation system, so that the limit values at the place of work are not exceeded.

It is an advantage of the method of the invention that removal of cleaning liquid from screen printing frames may be carried out quickly and effectively in direct extension of the actual washing of these by a simple manual or automatic operation.

It is advantageous to use compressed-air driven dust/liquid suction devices for supplying a vacuum suitable for cleaning liquid suction, as compressed-air driven dust/liquid suction devices are sparkless in contrast to e.g. electrically driven dust/liquid suction devices. The use of compressed-air driven dust/liquid suction devices thus considerably reduces the risk of ignition of the cleaning liquid.

The vacuum used for sucking cleaning liquid preferably corresponds to a negative pressure in relation to atmospheric pressure of 20-300 mbars, preferably 100-200 mbars.

Preferred compressed-air driven dust/liquid suction devices are those which are capable of generating a vacuum corresponding to a negative pressure in relation to atmospheric pressure of 100-200 mbars when supplying compressed air at a pressure of 2-4 bars and when supplying an air amount of 80-160 m³/hour.

The suction nozzle is preferably shaped such that the nozzle opening is essentially rectangular. Particularly preferred is a nozzle opening having a ratio of length to width greater than 5:1, preferably greater than 10:1, in particular greater than 20:1.

Further, the opening of the suction nozzle mazy advantageously be dimensioned such that it has a length corresponding to one of the internal edge lengths of the screen printing frames to be cleaned.

Compressed-air driven dust/liquid suction devices suitable for performing the method of the invention are commercially available and may be obtained e.g. from the company Støvsugerspecialisterne Danmark A/S.

The invention will be described more fuller below with reference to the drawing, in which

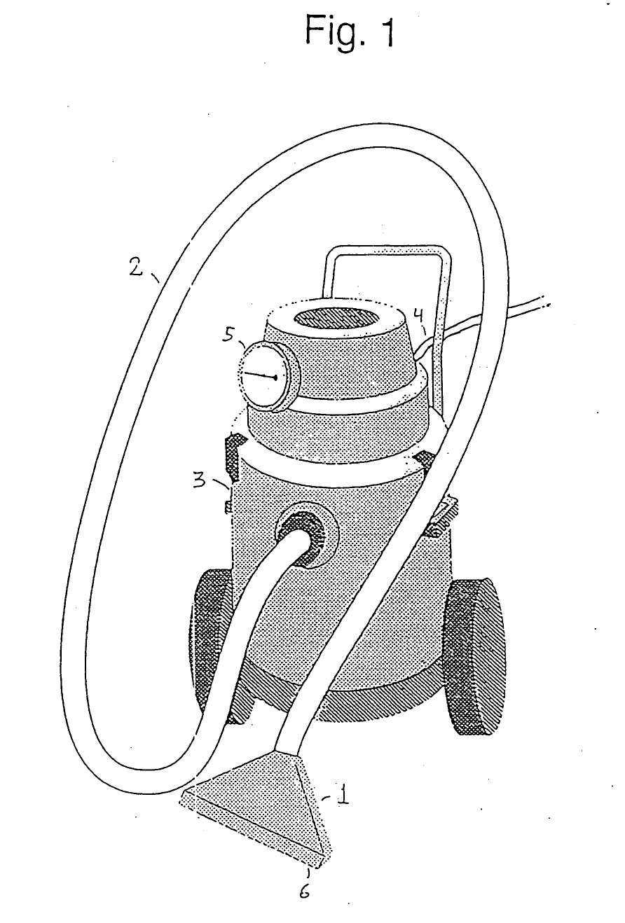

FIG. 1 is a sketch which illustrates a preferred structure of an apparatus for use in the performance of the method of the invention.

The apparatus comprises a suction nozzle (1), a pipe (2), preferably a flexible hose, for the transport of cleaning liquid, a dust/liquid suction device (3) having an internal container for the collection of cleaning liquid, a connection for compressed air (4), a manometer (5) and a connection for ventilation.

As the section nozzle (1), the pipe (2) and the internal container in the dust/liquid suction device contact cleaning liquid, these parts should consist of materials which are resistant to the cleaning liquid used, preferably of chemical-resistant materials.

The invention will be illustrated more fully below by a number of examples.

### EXAMPLE 1

Clean dry screen printing frames having an opening of 57×57 cm were weighed. Cleaning liquid was then applied to both sides of the fabric of the screen printing frames, following which the frames were immediately weighed. Cleaning liquid was then removed from the fabric by suction with a suction nozzle having a slot opening of 250×5 mm using a dust/liquid suction device having a suction capability of 100-190 mbars and a corresponding air amount of 15-30 l/s, and then the frames were weighed again.

Tests were performed with two different types of fabrics, a coarse one (48 T (threads/cm)) and a fine one (140 T (threads/cm)) as well as two different types of cleaning liquids, a fluid one (A5) having a viscosity of about 1 centipoise and a more viscous type (L3).

This produced the results shown in table 1 below:

TABLE 1

| | | | |
|---|---|---|---|
| | Liquid ab- | Liquid | Liquid |
| Liquid type | sorbed, g/m² | removed, g/m² | removed, % |

Fine web (140 T)

| | | | |
|---|---|---|---|
| A5 | 72 | 61 | 85 |
| L3 | 111 | 80 | 72 |

Coarse web (48 T)

| | | | |
|---|---|---|---|
| A5 | 114 | 85 | 795 |
| L3 | 144 | 104 | 72 |

### COMPARATIVE EXAMPLE

Corresponding tests were performed on a coarse web with L3 as the cleaning liquid, where the liquid was not removed by suction, but by wiping with sucking paper.

This produced the results shown in table 2 below:

TABLE 2

| | Liquid ab- | Liquid | Liquid |
|---|---|---|---|
| Liquid type | sorbed, g/m² | removed, g/m² | removed, % |
| L3 | 144 | 82 | 57 |

The results very clearly show the superiority of the present invention.

1. A method of cleaning screen printing frames, wherein the frame is contacted with a cleaning liquid which is capable of dissolving or washing out ink residues present in and/or on the screen fabric, and wherein cleaning liquid present in the screen fabric after dissolution of the ink residues is removed, characterized in that the removal of the cleaning liquid takes place by entraining it in a gas flow, and then the entrained liquid is preferably separated from the gas flow.

2. A method according to claim 1, characterized in that the maximum rate of the gas flow is in the range 5-60. m/s, preferably 10-45 m/s, in particular 15-30 m/s.

3. A method according to claim 1 or 2, characterized in that the removal of the cleaning liquid takes place by suction under vacuum by means of a suction nozzle which is moved across the screen fabric.

4. A method according to claim 3, characterized in that the cleaning liquid, having been sucked off from the screen fabric, is passed to a separation zone where the cleaning liquid is separated and collected.

5. A method according to claim 3 or 4, characterized in that the vacuum used for sucking off the cleaning liquid is supplied by a compressed-air driven dust/liquid suction device.

6. A method according to claims 3-5, characterized in that the vacuum used for sucking off the cleaning liquid corresponds to a negative pressure in relation to atmospheric pressure of 20-300 mbars, preferably 100-200 mbars.

7. A method according to claims 3-6, characterized in that the suction nozzle is shaped such that the nozzle opening is essentially rectangular.

8. A method according to claim 7, characterized in that the length to width ratio of the nozzle opening is greater than 5:1, preferably greater than 10:1, in particular greater than 20:1.
